(19) United States
(12) Patent Application Publication
(10) Pub. No.: US 2015/0060719 A1
(43) Pub. Date: Mar. 5, 2015

(54) Poppet seal

(71) Applicant: Timothy Schroeder, Maryland Heights, MO (US)

(72) Inventor: Timothy Schroeder, Maryland Heights, MO (US)

(21) Appl. No.: 14/121,298

(22) Filed: Aug. 15, 2014

Related U.S. Application Data
(60) Provisional application No. 61/959,600, filed on Aug. 28, 2013.

(51) Int. Cl. F16K 1/46; F16K 27/02

(52) U.S. Cl. CPC F16K 1/46; F16K 27/02
USPC 251/366

(57) ABSTRACT

A poppet seal is disclosed which comprises a poppet seal holder comprising a cylindrical base portion and a cylindrical central post extending up from a center of the base portion, the base portion having a bottom having an inner ring, and a fluoroelastomer compound ring molded into the inner ring of the poppet seal holder.

### CROSS REFERENCE TO RELATED APPLICATION

This nonprovisional patent application claims priority to the provisional patent application having Ser. No. 61/959,600, filed on Aug. 28, 2013.

### FIELD OF THE DISCLOSURE

This disclosure generally relates to a valve assembly for a gasoline or gasoline blended with ethanol dispensing nozzle, and more particularly, to an improved poppet seal in a dispensing nozzle to allow a user to control dispensing of fuel through the nozzle.

### BACKGROUND

Gasoline fuel dispensing nozzles are used to controllably regulate the flow of fuel, such as gasoline or gasoline blended with ethanol, from a storage tank into a gasoline tank in an automobile. In order to facilitate the rapid and efficient dispensing of the fuel from a storage tank to a user tank, fuel dispensing systems are designed to operate at a very high fluid flow rate. The fuel is pumped from the storage tank and through a metering system that tracks and records the amount of fuel dispensed by each user. The fuel then flows through a fuel line from the metering system to a dispensing nozzle that is placed in a fuel inlet or fuel filler neck attached to the user tank to enable the dispensing of fuel from the storage tank into the user tank.

Generally, a dispensing nozzle includes a handle that actuates a spring-loaded valve or poppet valve within the nozzle. When the handle is squeezed by the user, the valve opens to allow fuel to flow freely through the valve, through the nozzle, and into the user tank. When the handle is released, the spring shuts the valve and thereby shuts off the flow of fuel. A variety of poppet valve configurations are often used for this purpose in existing fuel dispensing nozzles.

Due to the desirability of high fuel flow rates, and the need for a reliable, positive shut-off of fuel for safety purposes, the spring that operates the poppet valve in most dispensing nozzles is very strong and requires a substantial force to compress.

The handles on dispensing nozzles operate as cantilevers to enable the user to overcome the force of the valve spring. Unfortunately, this flow control scheme is somewhat course, and the arrangement therefore offers the user only limited control over the amount of fuel dispensed through the dispensing nozzle. Historically, while such limited control over the dispensing of fuel was often a nuisance to the user, demand for more precise control did not warrant modification of the fuel dispensing systems. Recently, however, economic conditions and the rising costs of fuel have driven demand for more precise control over the dispensing of fuels. In particular, a customer may want to achieve “penny” dispensing. An example of “penny” dispensing is when the customer has dispensed $9.98 in fuel and wants to get an even $10.00. Without precise control, “penny” dispensing is difficult to achieve.

Some storage tanks are used to hold and dispense a fuel that is gasoline blended with a portion of ethanol. One such fuel is known as E85. E85 is an abbreviation for an ethanol fuel blend of 85% denatured ethanol fuel and 15% gasoline or other hydrocarbon by volume. E85 is commonly used by flex-fuel vehicles in the United States and other countries. It is also know to have a blended fuel of gasoline and a lesser percentage of ethanol. Known poppet seal constructions for E85 nozzles consist of two parts, a poppet seal holder and an elastic poppet seal. The poppet seal holder is used to contain and align the elastic poppet seal over a sealing seat to maintain a tight seal. A compressed spring in contact with the poppet seal holder is used to apply force to the poppet seal to maintain leak tight contact with the sealing seat. Since the poppet seal is not securely attached to the poppet seal holder, the seal can move independently during nozzle operation. In addition, there is a gap at the edge of the disc shaped poppet seal separating the seal from the poppet seal holder. Due to the current design of poppet seal constructions for E85 nozzles, the poppet seal is subject to developing cracks through the thickness of the seal at the points of contact with the seal seat. Cracks develop due to a tensile strength failure in the elastic material which is promoted by the gap at the edge of the disc shaped seal. The gap allows the poppet seal material to expand freely during each open and close cycle which eventually leads to material cracking, complete material separation, and finally leaks.

The present disclosure is designed to obviate and overcome many of the disadvantages and shortcomings experienced with prior poppet valves for dispensing fuel, such as E85. Moreover, the present disclosure is related to a poppet seal that is designed and constructed to prevent cracking and leaking by having a poppet seal and poppet seal holder in a single part or piece.

### SUMMARY OF THE DISCLOSURE

The present disclosure is a poppet seal which comprises a poppet seal holder comprising a cylindrical base portion and a cylindrical central post extending up from a center of the base portion, the base portion having a bottom having an inner ring, and a fluoroelastomer compound ring molded into the inner ring of the poppet seal holder.

In light of the foregoing comments, it will be recognized that the present disclosure provides a poppet seal that is simple to operate and seals against any fuel leaks in a fuel dispensing nozzle.

The present disclosure provides a poppet seal that can be easily employed with highly reliable results to be used to dispense fuel, such as E85, at a rapid flow rate.

The present disclosure also provides a poppet seal that allows a customer to control the amount of fuel dispensed with more precision then current valve designs afford.

The present disclosure further provides a poppet seal that is compatible with, and can be readily incorporated into, existing dispensing nozzles, without the need to reconfigure or modify the existing nozzle design.

The present disclosure provides a poppet seal that can be manufactured having the poppet seal and the poppet seal holder as a unitary part or piece.

These and other advantages of the present disclosure will become apparent to those skilled in the art after considering the following detailed specification in conjunction with the accompanying drawings.

### BRIEF DESCRIPTION OF THE DRAWINGS

In referring to the drawings:

FIG. 1 is a cross-sectional side view of a dispensing nozzle crusher constructed containing a poppet seal constructed according to the present disclosure;

FIG. 2 is a perspective view of the poppet seal constructed according to the present disclosure;

FIG. 3 is a top view of the poppet seal constructed according to the present disclosure;

FIG. 4 is a cross-sectional view of the poppet seal constructed according to the present disclosure taken along the plane of line 4-4 in FIG. 3; and

FIG. 5 is a bottom view of the poppet seal constructed according to the present disclosure.

### DETAILED DESCRIPTION OF PREFERRED EMBODIMENTS

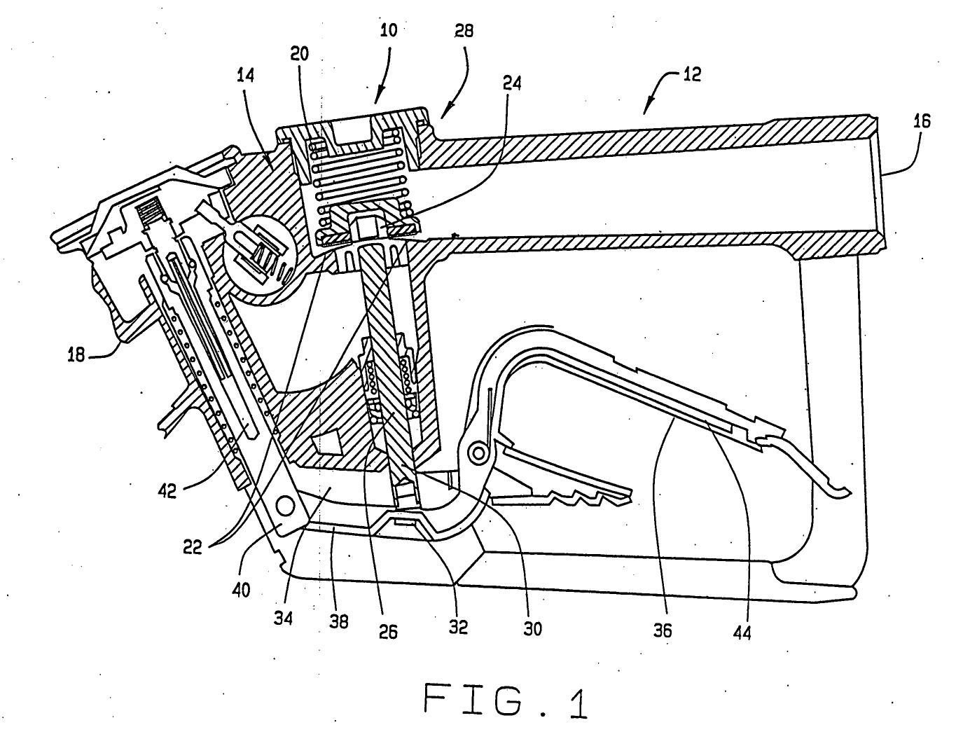

Referring now to the drawings, wherein like numbers refer to like items, number 10 identifies a preferred embodiment of a poppet seal constructed according to the present disclosure. With reference now to FIG. 1, the poppet seal 10 is shown installed within a dispensing nozzle 12. The nozzle 12 includes a body 14 having an inlet 16 to which a fuel hose (not shown) is connected. The nozzle 12 also has an outlet or spout assembly 18 which is adapted to be inserted into the fill pipe of an automobile fuel tank (all of which are not shown). The poppet seal 10 is disposed within the body 14 between the inlet 16 and outlet 18. The poppet seal 10 is biased by a spring 20 into a sealing engagement against a poppet valve seat or sealing seat 22. The poppet seal 10 is mounted to an upper end or a poppet skirt 24 of a valve stem 26. The poppet seal 10 is located in an upper portion 28 of the body 14, and the valve stem 26 extends downwardly through the body 14 to a lower end 30. The lower end 30 of the stem 26 projects through an opening 32 in a base 34 of the body 14 of the nozzle 12. An operating lever 36 for the nozzle 12 has a pivoting functional end 38 connected to a lower end 40 of an automatic shut-off plunger 42. The lever 36 has another end 44 that is grasped by a hand of a user, and when squeezed, the upward pressure on the lever 36 forces the valve stem 26 upwardly. This moves the poppet seal 10 off the valve seat 22, opening the poppet seal 10, and permitting fuel to flow into the spout assembly 18. In this position, the poppet seal 10 is in an open position. When the shut-off plunger 42 is operated, the lever 36 is moved to its initial position and the spring 20 forces the poppet seal 10 back into engagement with the valve seat 22. In this position, the poppet seal 10 is in a closed position and no fuel may flow through the nozzle 12.

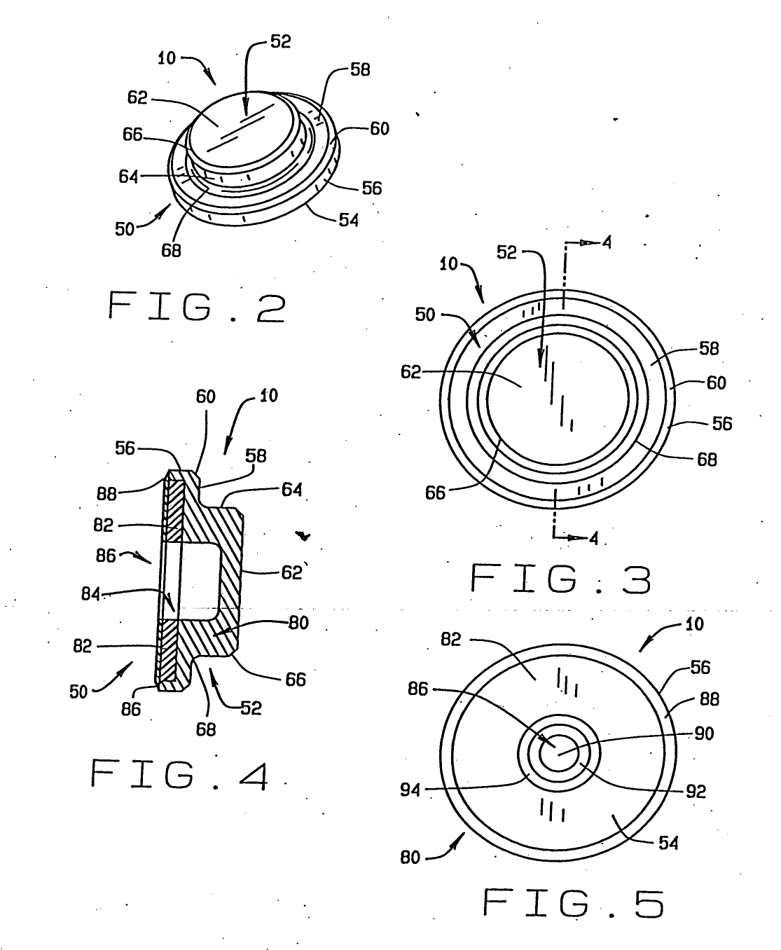

FIG. 2 shows a perspective view of the poppet seal 10. The poppet seal 10 has a cylindrical base portion 50 and a generally cylindrical central post 52 extending up from the center of the base portion 50. The base portion 50 has a bottom 54, a side 56, and a top 58. A chamfered or beveled edge 60 is formed between the side 56 and the top 58. The central post 52 has a top 62, a side 64, and a chamfered or beveled edge 66 formed between the top 62 and the side 64. A rounded edge 68 is farmed between the top 58 and the side 64. The top 58 is sized and shaped to receive the spring 20 due to the spring 20 having an outer diameter that is less than the diameter of the top 58. The top 58 forms a shoulder or a flange upon which the spring 20 is biased or pressed against. The spring 20 is capable of biasing the poppet seal 10 along the top 58. Also, the central post 52 is sized and shaped to fit within the spring 20. The bottom 54 is sized and shaped to engage the poppet valve seat 22.

With reference now to FIG. 3, a top view of the poppet seal 10 is shown. The poppet seal 10 is shown having the central post 52 extending up from the base portion 50. The base portion 50 has the side 56, the top 58, and the chamfered edge 60. The central post 52 has the top 62 and the chamfered edge 66. The rounded edge 68 is also shown. The top 58 is adapted to receive the spring 20. The top 58 presents a surface upon which and against which the spring 20 is biased.

FIG. 4 illustrates a cross-sectional view of the poppet seal 10. The poppet seal 10 is formed having a poppet seal holder 80 having a molded ring 82 positioned within an inner ring 84 of the poppet seal holder 80. The poppet seal holder 80 may be constructed of stainless steel, aluminum, and glass filled PET, as well as any other suitable material. The molded ring may be formed of any elastomer that contains fluorine. Some examples of fluoroelastomers include, but are not limited to, copolymers of i) vinylidene fluoride, hexafluoropropylene and, optionally, tetrafluoroethylene; ii) vinylidene fluoride, perfluoro (methyl vinyl ether) and, optionally, tetrafluoroethylene; iii) tetrafluoroethylene and propylene; and iv) tetrafluoroethylene and perfluoro (methyl vinyl ether). The poppet seal 10 is a single part having the molded ring 82 of the fluoroelastomer compound fused or molded to the inner ring 84 of the poppet seal holder 80. The fluoroelastomer compound is flexible and the material will withstand exposure to gasoline or other fuels to which it may be exposed. The elastic material will progressively conform to the contour of the sealing seat 22 which increases the contact area, thus sealing integrity between the bottom 54 and the sealing seat 22 after every cycle. Along the bottom 54 of the base portion 50 is a hollow interior or bore 86 that is adapted to receive the-upper end 24 of the valve stem 26. The bore 86 extends from the bottom 54 into the central post 52. The bottom 54 is capable of engaging the poppet valve seat 22 when the bias of the spring 20 presses the poppet seal 10 into the closed position to form a liquid tight seal to prevent any fuel or liquid to pass from the inlet 16 to the outlet 18. A chamfered edge 88 of the molded ring 82 is formed between the bottom 54 and the side 56 by over molding the material that forms the molded ring 82. Other examples of the material that may be used to form the molded ring 82 are RT/Dygert F-7020 or RT/Dygert FLT-7001.

Referring now to FIG. 5, a bottom view of the poppet seal 10 is depicted. The poppet seal 10 has the chamfered edge 88 formed between the bottom 54 and the side 56 by over molding. The bore 86 has a top surface 90, a side 92, and an edge 94 formed between the side 92 and the bottom 54. The top surface 90 and the side 92 are adapted for receiving the upper end 24 of the valve stem 26.

Referring again to FIG. 1, the poppet seal 10 is movable between a fully closed position in which the poppet seal 10 blocks the flow of fuel through the dispensing nozzle 12, and an open or raised position in which the poppet seal 10 is clear of valve seat 22 so as to permit the rapid flow of fuel from the inlet 16 to the outlet 18. When the lever 36 is raised, as by a user desiring to pump gasoline through the nozzle 12, the lever 36 engages and pushes in an upward direction the valve stem 26. The upward movement of the valve stem 26 initially pushes the upper end 24 against the bottom 54 of the poppet seal 10, thereby raising the poppet seal 10 off the sealing seat 22, and against the pressure exerted by the spring 20 and the fuel pressure. The poppet seal 10 moves to an open position to allow fuel to flow through the nozzle 12. Accordingly, movement of the lever 36 and the valve stem 26 can be controlled to open the poppet seal 10 to allow a limited flow of fuel between the inlet 16 and the outlet 18 through the nozzle 12.

The poppet seal 10 enables a user to easily, accurately and controllably dispense small quantities of fuel through the same nozzle 12 through which large volumes of fuel may also be dispensed. By merely controlling the degree that the lever 36 and the stem 26 are raised, the user can select between high and low fuel flow rates in the same nozzle 12. A slower, yet more accurate and controllable dispensing of fuel through the nozzle 12 is achieved by squeezing the lever 36 only slightly so that the stem 26 opens only the poppet seal 10 a corresponding small amount. Rapid, but relatively coarse dispensing of fuel through the nozzle 12 is achieved by squeezing the lever 36 sufficiently such that the stem 26 opens the poppet seal 10 all the way. In this manner of operation, small volumes of fuel can be dispensed through the poppet seal 10 at a low rate so as to allow the user to determine more precisely when to release the lever 36 to shut off the flow of fuel.

One advantage of the present poppet seal 10 is that it provides for “penny” dispensing of fuel. In a conventional fuel dispensing nozzle, the flow rate when the conventional fuel flow valve is fully open is approximately 10 gallons per minute (gpm), and the user can controllably reduce this flow rate to approximately 2 gpm when the fuel flow valve is nearly closed. This means that at a price of $1.00 US per gallon, at 2 gpm, the customer is dispensing fuel at a rate of 1 penny every 0.3 seconds. At this flow rate, the customer can attempt to stop the flow of fuel at a desired amount. However, when the price of fuel is $4.00 per gallon, the fuel flow equates to 1 penny every 0.075 seconds and this is too rapid even for an experienced customer to controllably stop the fuel flow at a desired amount.

Another advantage of the current invention is that since the seal material is formed of an elastomer, trapped within its cylindrical base portion 50, when molded therein, after repeated usage and application within the nozzle, the elastomer material has a tendency to conform to the configuration of the poppet skirt 24, and therefore provide even a greater seal, over the long term, as a result of repeat usage.

With known poppet seals consisting of a separate popper holder and a separate poppet seal, fast flowing fuel has a tendency to suck the poppet seal away from the holder near the edges which causes significant fluctuations in flow. The dramatic changes in fuel flow can make it very difficult for the customer to achieve “penny” dispensing. With the poppet seal 10 of the present disclosure, “penny” dispensing is achieved because the seal 10 cannot be sucked down.

From all that has been said, it will be clear that there has thus been shown and described herein a poppet seal. It will become apparent to those skilled in the art, however, that many changes, modifications, variations, and other uses and applications of the subject poppet seal are possible and contemplated. All changes, modifications, variations, and other uses and applications which do not depart from the spirit and scope of the disclosure are deemed to be covered by the disclosure, which is limited only by the claims which follow.

What is claimed is:

1. A poppet seal comprising:
a poppet seal holder comprising a cylindrical base portion and a cylindrical central post extending up from a center of the base portion, the base portion having a bottom having an inner ring; and
a fluoroelastomer compound ring molded into the inner ring of the poppet seal holder.

2. The poppet seal of claim 1 wherein the fluoroelastomer compound ring has a chamfered edge.

3. The poppet seal of claim 1 wherein the base portion comprises a bottom, a side, and a top.

4. The poppet seal of claim 1 wherein the central post comprises a top and a side.

5. The poppet seal of claim 1 wherein the central post comprises a top, a side, and a chamfered edge formed between the top and the side, and a rounded edge formed between the top of the base portion and the side of the central post.

6. The poppet seal of claim 1 wherein the poppet seal holder is formed from stainless steel.

7. The poppet seal of claim 1 wherein the poppet seal holder has a bore.

8. The poppet seal of claim 1 wherein the fluoroelastomer compound ring is formed having a chamfered edge by over molding the fluoroelastomer compound ring.

9. The poppet seal of claim 1 wherein the elastic portion of the poppet seal is completely trapped on all sides except for the direction of sealing or the dynamic sealing surface in cyclical contact with the sealing surface.

10. The poppet seal of claim 1 wherein the ring is restricted from moving within the poppet seal holder.

11. The poppet seal of claim 1 wherein the ring is sealed to the poppet seal holder so that the ring is restricted from moving independent of the poppet seal holder.

12. The poppet seal of claim 1 wherein the ring is confined within the poppet seal holder to prevent movement of the ring relative to the poppet seal holder.

13. The poppet seal of claim 1 wherein said poppet seal is used in conjunction with a poppet and the fluoroelastomer compound ring conforms to the shape of the poppet after prolonged usage and application.
